(19) United States
(12) Patent Application Publication
(10) Pub. No.: US 2025/0126044 A1
(43) Pub. Date: Apr. 17, 2025

(54) MULTI-LEVEL PORT TRANSLATION FOR ROUTING IN NETWORKS

(71) Applicant: Intel Corporation, Santa Clara, CA (US)

(72) Inventors: Kartik LAKHOTIA, San Jose, CA (US); Hossein FARROKHBAKHT, Toronto (CA); Gurpreet Singh KALSI, Portland, OR (US); Fabrizio PETRINI, Menlo Park, CA (US)

(21) Appl. No.: 18/981,161

(22) Filed: Dec. 13, 2024

(51) Int. Cl. H04L 45/02; H04L 45/00

(52) U.S. Cl. CPC H04L 45/02; H04L 45/34

(57) ABSTRACT

Examples described herein relate to performing source routing of a packet to route the packet from a source to a destination through multiple routers by specification of a path of logical port identifiers through the multiple routers. In some examples, multiple routers are to translate the logical port identifiers into physical ports based on configurations. In some examples, the path of the packet through the multiple routers is based on a topology of the routers.

### BACKGROUND

A network provides communications among devices, such as processors, accelerators, memory, and storage devices. Routing a packet from a source to destination involves setting a path for the packet based on the topology of the network. The computation of a packet route depends on the type of the routing employed. The topology of a network is a physical or logical description of the placement and connectivity between nodes or switches in the network. The topology can be represented as a graph. For instance, an all-to-all topology uses a fully connected graph where every switch is directly connected to every other switch.

### BRIEF DESCRIPTION OF THE DRAWINGS

FIG. 1 depicts an example network.

FIG. 2 depicts an example switch.

FIG. 3 depicts an example look up table.

FIG. 4 depicts an example topology.

FIG. 5 depicts an example topology.

FIG. 6A depicts an example process.

FIG. 6B depicts an example process.

FIG. 7 depicts an example switch.

FIG. 8 depicts an example process.

### DETAILED DESCRIPTION

For source routing, the entire path of the packet is computed at the sender network interface device or source switch. The path can be represented as a sequence of output ports to traverse. The switches in the path select an output port for the packet from the sequence based on the number of hops incurred. Route computation in source routing can be complex since it does not compute the path incrementally. A uniform logical port map is desirable to simplify route computation. However, while the wiring ensures that desired number of links are present between pairs of adjacent switches in the logical topology, it may not be possible to enforce the usage of a particular port (as given by the logical map) for a given connection. Moreover, different switches may use different ports for the same logical connection. For example, in an all-to-all topology, switches j and k may use physical ports j′≠i and k′≠j′, respectively, to connect to switch i even though a logical mapping may dictate use of port i for this purpose. Lastly, in some networks, one or more links may be fat, as there are multiple physical links between the corresponding pair of adjacent switches, which may be difficult to incorporate in route computation. To summarize, a uniform logical port mapping used for algorithmic route computation may not correctly describe actual physical paths in the network. Various examples of topologies include, but are not limited, to: all-to-all, HyperX, Megafly, PolarFly, SlimFly, Dragonfly, Fat-Tree, or PolarStar.

Various examples utilize a multi-level port mapping scheme which decouples algorithmic route computation, link fatness, and physical wiring, and provides mapping of a route of a packet through switches to a destination network interface device. Switches can utilize port translation tables to convert from one level to another. A logical port mapping follows the logical topology description whereby there is exactly one logical link per pair of adjacent switches. Different logical ports can map to a different number of virtual ports to allow for variable fatness across the links. In some examples, one virtual port maps to one or fewer physical port and thus, a virtual port sequence from a source identifies a unique physical path in the network to provide deterministic route computation through a network to a destination. Virtual port mapping align with topological description so that virtual paths can be computed at the source sender device. Physical port mapping allows arbitrary port(s) to be used for any connection as long as a physical port is used for at most one logical link.

Various examples can provide one or more of the following advantages, but are not necessary features: decouple logical port assignments used for route computation from physical port assignments that align with the network wiring; handle fat links (e.g., packets are transmitted over multiple links between switches) to improve path diversity and available bandwidth and allow variable fatness across different ports; reduce physical ports lost to disconnection; enables deterministic routing paths even in the presence of fat links, traceability of exact paths used by the packets, retransmission on specific paths; permit physical port assignments that can accommodate arbitrary wiring constraints; or translation between multiple port mapping domains can be accomplished with negligible memory and latency overheads.

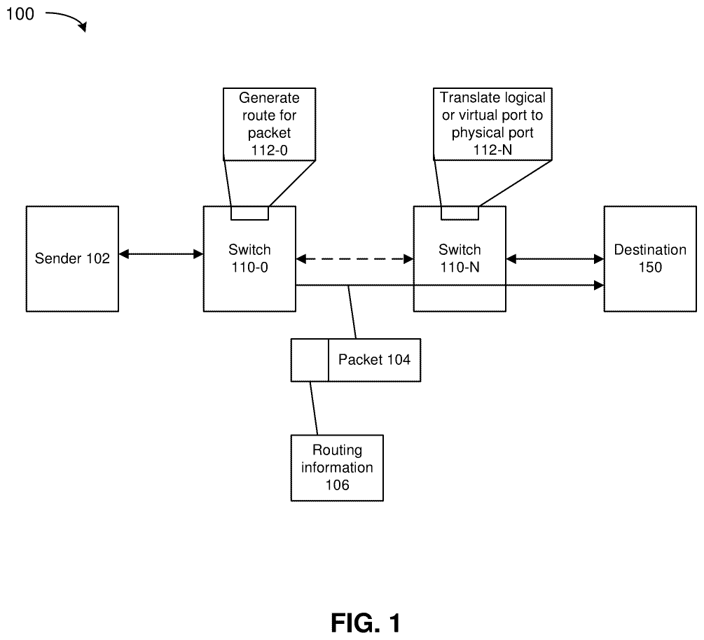

FIG. 1 depicts an example network of devices. The network of devices can be part of a network on chip (NoC) design, which can attempt to prevent deadlock, which occurs when a group of packets that share some resources remain in a perpetual waiting state due to a circular dependency. Sender network interface device 102 can transmit packets to destination network interface device 150 via switches 110-0 to 110-N, where N is an integer. Switches 110-0 to 110-N, where Nis an integer, can forward packets transmitted from sender 102 to destination 150.

As described herein, one or more of switches 110-0 to 110-N can apply a port mapping scheme to translate a logical port identifier or virtual port identifier to a physical output port for a switch to enable route computation and flexible output port wiring. In some examples, sender network interface device 102 and/or first hop switch 110-0 can perform source routing at 112-0 to calculate a logical port route 106 for packet 104, through one or more of switches 110-0 to 110-N, to destination network interface device 150. The logical port route 106 can represent a path of packets of a flow from sender 102 to destination network interface device 150 via one or more of switches 110-0 to switch 110-N as a sequence of logical port identifiers or virtual port identifiers.

Where switches 110-1 to 110-N perform source routing at 112-0 to calculate a virtual port route for packet 104, through one or more of switches 110-0 to 110-N, to destination 150. A virtual port path can represent a number of wired or wireless connections or links between switches. In some examples, for switches 110-0 to 110-N, logical port to virtual port mappings can be the same. However, mapping of virtual ports to physical ports can change at different switches as physical port mapping can be unique for different switch and can depend on what ports of a switch are connected to which other switch. A virtual port can map to at most one physical port and hence, a virtual port sequence from a source to destination can identify a physical path through the network. Thus, virtual port mappings can enable deterministic route computation.

One or more of switches 110-1 to 110-N can perform respective translation operations 112-1 to 112-N to translate logical or virtual port information from routing information 106 in a header and/or payload field of packet 104 to a physical output port. One or more of switches 110-1 to 110-N can egress packet 104 from the respective translated physical output port to destination network interface deice 150. As described herein, one or more of switches 110-0 to 110-N can utilize logical port to virtual port translation tables and/or virtual to physical port translation tables that can be queried with an index of a logical or virtual port identifier. Port translation tables can be populated at boot time based on the topology configuration and the physical wiring for switches 110-0 to 110-N and may be updated at runtime due to events such as link failures. Translation tables can be stored in registers for low-latency access. Physical port mapping port assignment can represent the physical wiring of the network and allow arbitrary port(s) to be used for a connection for different switches. A data center administrator or orchestrator can configure one or more of: logical-to-virtual port mappings in switches, virtual-to-physical port mappings in switches, or network topology.

In some examples, sender network interface device 102, one or more of switches 110-0 to 110-N, and/or destination network interface device 150 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding element or forwarding device can include a router and/or switch.

A packet may be used herein to refer to various formatted collections of bits that may be sent across a network, such as Ethernet frames, Internet Protocol (IP) packets, Transmission Control Protocol (TCP) segments, User Datagram Protocol (UDP) datagrams, etc. In some examples, a flow control unit (flit) can represent a portion of a packet and flits can be transmitted between networking devices in a network or NoC.

A flow can include a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination UDP ports, source/destination TCP ports, or any other header field) and a unique source and destination queue pair (QP) number or identifier.

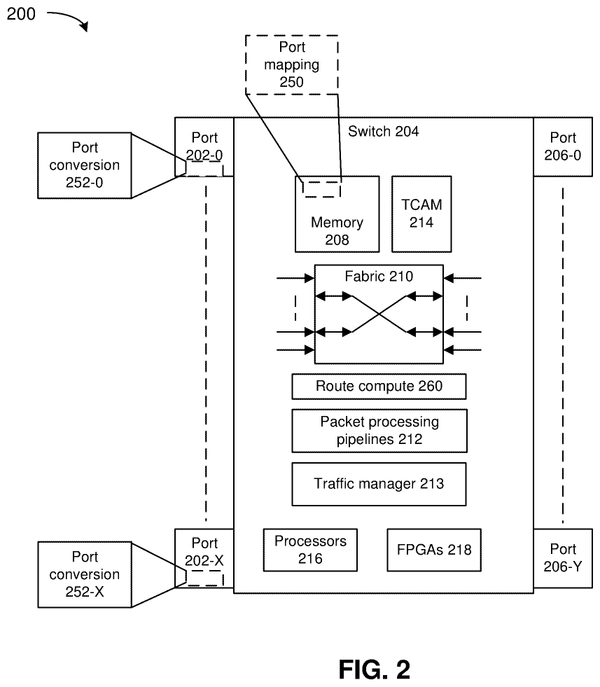

FIG. 2 depicts an example of a system. Switch system 200 can be utilized in a NoC or network to transmit packets or flits. Switch 204 can route packets, flits, or frames of any format or in accordance with any specification received from any port 202-0 to 202-X to output from one or more of ports 206-0 to 206-Y (or vice versa), where X and Y are integers. One or more of ports 202-0 to 202-X can be connected to a network of one or more interconnected devices (e.g., switch or network interface device). Similarly, one or more of ports 206-0 to 206-Y can be connected to a network of one or more interconnected devices (e.g., switch or network interface device).

For example, where switch 200 is to a first hop router or is configured to perform path computation, input ports 202-0 to 202-X can perform respective port conversion operations 252-0 to 252-X to generate logical or virtual port identifiers for a sequence of hops to a destination network interface device. Assignment of logical ports can follow a logical topology description with one logical link per pair of adjacent switches.

For example, where switch 200 is to not a first hop router and is not configured to perform path computation, based on port mapping 250, port conversion 252-0 to 252-X for respective input ports 202-0 to 202-X and/or route compute circuitry 260 can: (1) for a received logical port path in a received packet, convert a next logical port identifier to a particular physical port based on logical to physical port mapping 250 or (2) for a received virtual port identifier of a received packet, convert a next virtual port identifier to a particular physical port based on logical to physical port mapping 250.

In some examples, switch fabric 210 can provide routing of packets from one or more ingress ports 202-0 to 202-X for processing prior to egress from switch 204. Switch fabric 210 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 208 can be configured to store packets received at ports prior to egress from one or more ports 206-0 to 206-Y. Packet processing pipelines 212 can include ingress and egress packet processing circuitry to respectively process ingressed packets and packets to be egressed. Packet processing pipelines 212 can determine which port to transfer packets or frames to using a table that maps packet characteristics with an associated output port. Packet processing pipelines 212 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 212 can implement access control list (ACL) or packet drops due to queue overflow.

Configuration of operation of packet processing pipelines 212, including its data plane, can be programmed using Programming Protocol-independent Packet Processors (P4), C, Python, Broadcom Network Programming Language (NPL), or x86 compatible executable binaries or other executable binaries.

Traffic manager 213 can perform hierarchical scheduling and transmit rate shaping and metering of packet transmissions from one or more packet queues.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

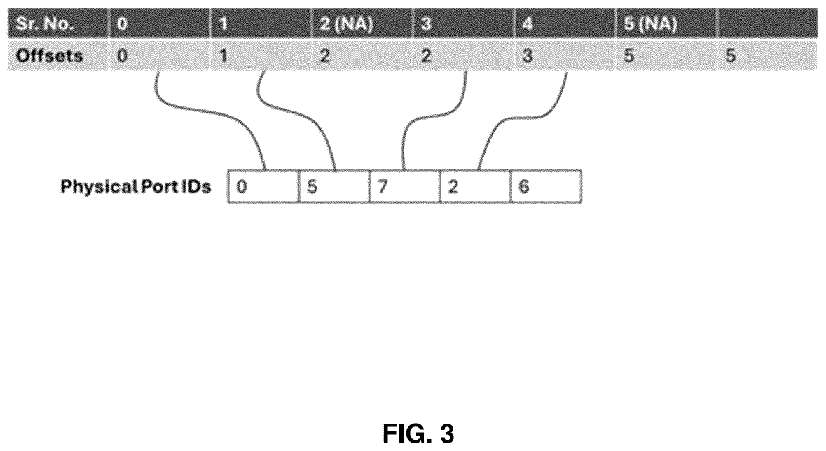

FIG. 3 depicts an example translation table. In some examples, a single translation table from logical to physical domain can be used in port mapping 250. The table's entries can be different for different switches. A logical port can map to multiple physical ports with possibly non-contiguous physical port identifiers (IDs). The table can be implemented as a sparse matrix data structure such as the Compressed Sparse Row (CSR). In CSR format, physical ports corresponding to a logical port are enumerated in a list. The list can be concatenated in the order of the logical port identifiers (IDs) and an offset array is maintained to indicate the starting position of the target list. The offset for the next list demarcates an end of the current list and if a list offset is same as the offset of the next list, this implies that the list is empty. Querying a CSR can involve reading the offset and then using the offset to index a physical port ID array. Note that disconnected logical ports may have the same offset as the next logical port ID indicating their list of physical port IDs is empty.

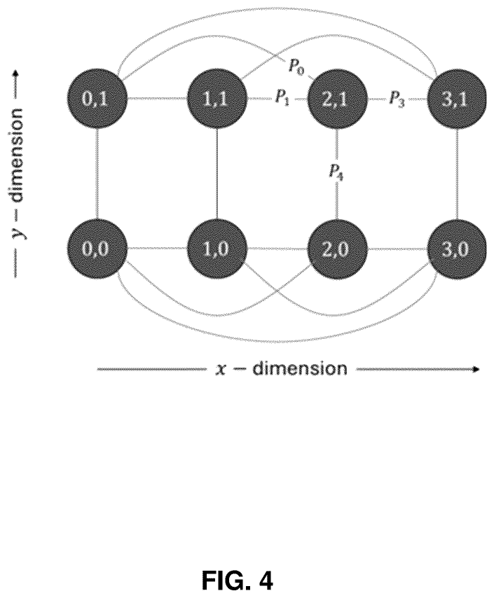

FIG. 4 depicts an example HyperX network topology with 8 switches arranged in a two-dimensional lattice. The following provides an example of port assignments for multi-level port assignments with an example of a 2D HyperX of size 4×2. A switch can be represented with 2D coordinates (x, y) and a switch is adjacent to all other switches (x, y′≠y) in the same column and (x′≠x, y) in the same row. In this example, a switch has 8 physical ports and 4 ports are assigned for each dimension. Thus, the fatness in x-dimension is 1 and in y-dimension is 2.

A logical port assignment can utilize 6 logical ports per switch. For example, ports {0, 1, 2, 3} can be used to route a packet in the x-dimension and ports {4, 5} can be used to route a packet in the y-dimension. Specifically, for any switch (x, y): (1) a logical port i connects the switch in x-dimension to (switch, port) (i, y) if 0≤i<3 and (2) a logical port i+4 connects the switch in y-dimension to (switch, port) (x, i) if 0≤i<2.

To compute a logical path from (x, y) to (x′, y′), both the coordinates can be corrected one at a time, such as by port sequence {x′, y′+4} or {y′+4, x′}. Thus, route computation with logical ports can utilize one addition if the destination coordinates are known.

In the x direction, to find a logical port for a next switch, a logical port corresponds to x coordinate of a neighbor. For example, (0,1) to (1,1) changes x coordinate=0 to 1, so that logical port 1 connects (1,1) to (0,1). For example, (2,1) to (1,1) changes x coordinate=2 to 1, so that logical port 1 connects (1,1) to (2,1).

In the y direction, to find logical port for next switch, a logical port corresponds to y coordinate of neighbor. For example, (0,1) to (0,0) changes y coordinate=1 to 0, so logical port 4 connects (0,0) to (0,1). In this example, there is no logical port 5 for (0,1). For example, (0,0) to (0,1) changes y coordinate=0 to 1, so logical port 5 connects (0,1) to (0,0). There is no logical port 4 for (0,0).

As fatness in x-dimension is 1, logical port i maps to virtual port i for all 0≤i<4. In the y-dimension, fatness is 2 and hence, the logical port 4+i maps to virtual ports 4+2i and 4+ (2i+1). For logical ports, the first and the last virtual port ID can be specified as shown in Table 1.

TABLE 1

| Logical Port ID | Virtual Port IDs |
|---|---|
| 0 | 0 |
| 1 | 1 |
| 2 | 2 |
| 3 | 3 |
| 4 | 4, 5 |
| 5 | 6, 7 |

Logical ports P₂ and P₅ are self-loops for (2,1) and are not shown. Logical port assignments for switches can follow the same pattern even though the self-loop ports can be different for different switches. Note that some logical ports on each switch (x, y) can be self-loops that logically connect the switch to itself. Specifically, ports x and y+4 are self-loops. Physically, these logical ports are not implemented and they may either map to a dummy physical port or to some physical ports that are dangling/disconnected. Virtual port assignments for switches can follow the same pattern even though the self-loop ports can be different for different switches. Corresponding to the logical self-loops {x, y+4}, virtual ports {x, 4+2y, 5+2y} are disconnected. Thus, for 8 virtual ports, only 5 virtual ports are connected. Also note that virtual ports [0,3] can be used for connectivity in x-dimension and [4,7] are used for connectivity in y-dimension.

Physical ports can be dictated by wiring and the virtual port to physical port mapping can be arbitrary and distinct for each switch. However, one virtual port maps to at most one physical port and hence, at most 5 physical ports are connected in this setup. At least 3 physical ports are disconnected, which is 37.5% of the total bandwidth of the switch.

An example virtual to physical port translation table for switch (1,0) in the 2D-HyperX is shown in Table 2:

TABLE 2

| Virtual port ID | Physical Port ID |
|---|---|
| 0 | 0 |
| 1 | NA |
| 2 | 5 |
| 3 | 7 |
| 4 | NA |
| 5 | NA |
| 6 | 1 |
| 7 | 2 |

An example virtual to physical port translation table for switch (2,1) in the 2D-HyperX is shown in Table 3:

TABLE 3

| Virtual port ID | Physical Port ID |
|---|---|
| 0 | 0 |
| 1 | 5 |
| 2 | NA |
| 3 | 7 |
| 4 | 2 |
| 5 | 6 |
| 6 | NA |
| 7 | NA |

For the disconnected virtual ports, a dummy physical port ID can be used for an indication (shown as NA). For switch (2,1), logical ports 2 and 5 (virtual ports 2, 6 and 7) are disconnected. When a switch determines that the respective virtual port is disconnected, it may read the next port in the path sequence of the packet, convert the next port to the physical output port and route the packet accordingly.

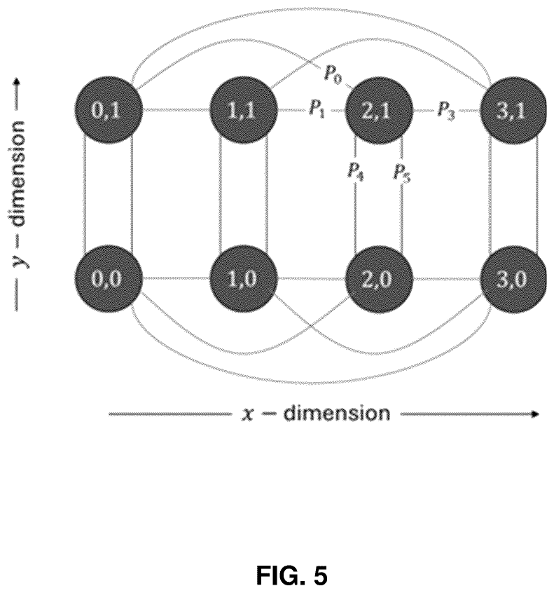

FIG. 5 depicts a 4X2 2D-HyperX example that uses 8-port switches. The example of FIG. 5 utilizes a same logical port ID mapping as that of FIG. 3, however, as there are two physical links between switches in the y direction, virtual ports can represent two physical ports. The network of FIG. 4 had a fatness of 1 in x-dimension and 2 in y-dimension, which leads to 3 disconnected physical ports. The example of FIG. 5 changes the fatness in y-dimension to 4 and reduces the disconnected physical ports to 1. The logical self-loop is not mapped to a physical port. However, since the logical to virtual translation must be uniform across all switches, map the self-loop to 4 virtual ports. In this case, the logical to virtual port translation table is populated as shown below:

TABLE 4

| Logical Port | Start Virtual Port | Last Virtual Port |
|---|---|---|
| ID | ID | ID |
| 0 | 0 | 0 |
| 1 | 1 | 1 |
| 2 | 2 | 2 |
| 3 | 3 | 3 |
| 4 | 4 | 7 |
| 5 | 8 | 11 |

Since logical ports 2 and 5 are self-loops on this switch, map their corresponding virtual ports to NA. An example virtual to physical translation table for switch (2,1) is shown below:

TABLE 5

| Virtual port ID | Physical Port ID |
|---|---|
| 0 | 0 |
| 1 | 5 |
| 2 | NA |
| 3 | 7 |
| 4 | 2 |
| 5 | 6 |
| 6 | 3 |
| 7 | 4 |
| 8 | NA |
| 9 | NA |
| 10 | NA |
| 11 | NA |

Table 5 shows that physical port 1 is disconnected and other physical ports are used. While the range of virtual ports has increased from [0,7] in the previous scenario to [0,11] with the updated virtual port assignment, the range of physical ports used is still within [0,7] which can be accomplished in an 8-port switch. The number of virtual ports is not constrained by the number of physical ports and the range of virtual ports can be easily extended as per need.

In case of fat links, an example manner to handle link failures would be to overwrite the corresponding entry in the virtual to physical translation table. The updated entry would point to another active physical port which also connects to the same neighboring switch as the failed port. Thus, packets coming towards failed links can be correctly routed on-the-fly without making any changes in the routing table or the route computation algorithm.

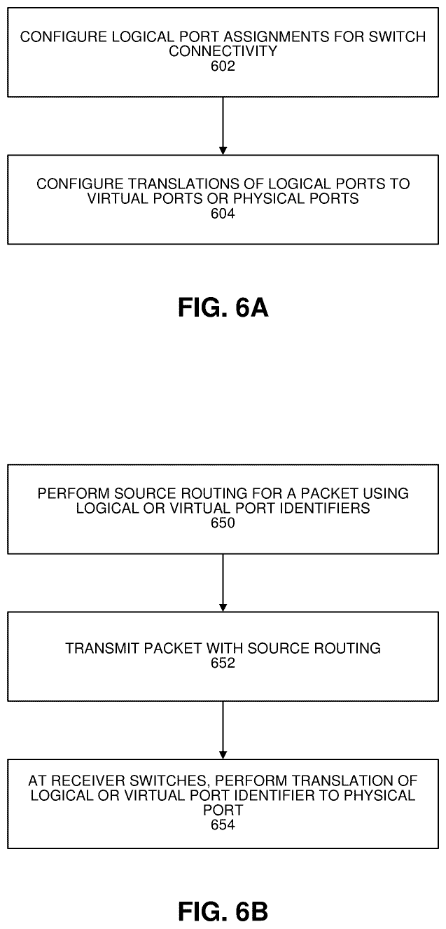

FIG. 6A depicts an example process. The process can be performed by a data center administrator or orchestrator of a network. At 602, a logical port path or virtual port path of packets through switches from one or more sender network interface devices to one or more destination network interface devices can be configured. At 604, switches can be configured to associate logical or virtual ports to physical ports in the switches.

FIG. 6B depicts an example process. At 650, based on receipt of a packet at a first hop switch from an endpoint sender, a path of logical port identifiers to the packet can be assigned to the packet to perform source routing. At 652, the first hop switch can transmit the packet to a second switch. At 654, based on receipt of packet at a second or subsequent hop switch, the second or subsequent hop switch can translate a logical port identifier to a physical port. For example, based on configurations, logical ports can be translated to virtual ports and virtual ports can be translated to physical ports. Logical port to physical port translation can occur via translation tables and/or algorithmic conversions.

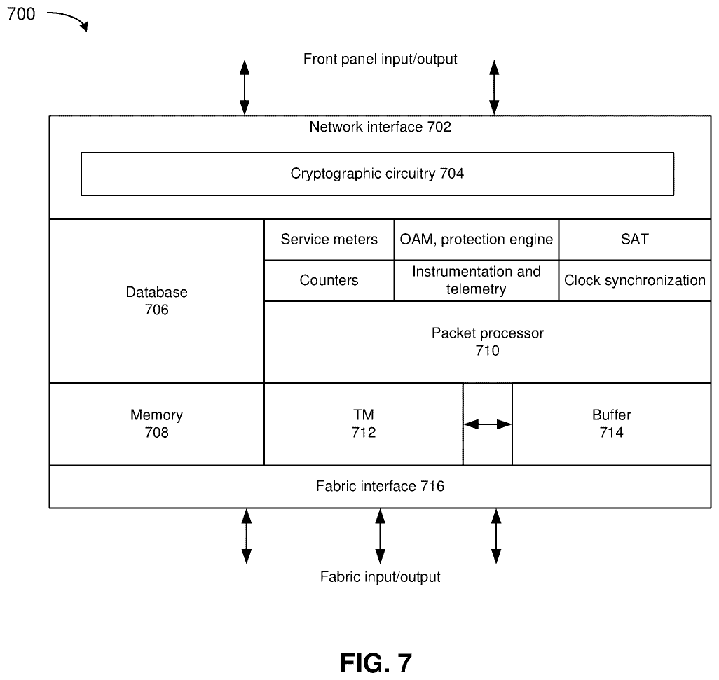

FIG. 7 depicts an example switch. Various examples can be used to provide connectivity among multiple switches, as described herein. Switch 700 can include a network interface 700 that can provide an Ethernet consistent interface. Network interface 700 can support for 25 GbE, 50 GbE, 100 GbE, 200 GbE, 400 GbE Ethernet port interfaces. Cryptographic circuitry 704 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 706 can store a device's profile to configure operations of switch 700. Memory 708 can include High Bandwidth Memory (HBM) for packet buffering. Packet processor 710 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 710 can include one or more FPGAs. Buffer 714 can store one or more packets. Traffic manager (TM) 712 can provide per-subscriber bandwidth guarantees in accordance with service level agreements (SLAs) as well as performing hierarchical quality of service (QOS). Fabric interface 716 can include a serializer/de-serializer (SerDes) and provide an interface to a switch fabric. A switch SoC can be coupled to other devices in a switch system such as ingress or egress ports, memory devices, or host interface circuitry.

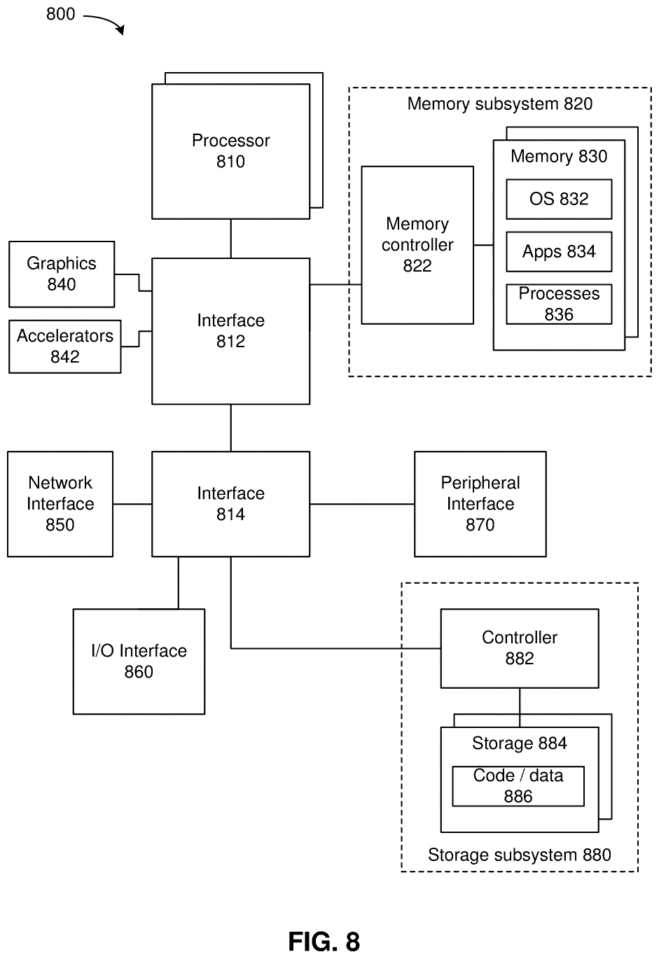

FIG. 8 depicts a system. In some examples, components of system 800 can be connected using wiring of ports as described herein. For example, interface 812 and/or 814 can be wired by connection of one or more fully connected shuffle boxes and/or one or more complete bipartite shuffle boxes. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board. A system in package (SiP) can include a package that encloses one or more of: a system on chip (SoC), one or more tiles, or other circuitry.

In an example, system 800 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes a method that includes: in a switch among multiple switches connected according to a topology in a network on chip (NoC): to route a packet from a source to a destination through the multiple switches: assign logical port identifiers to links between switches of the multiple switches; and assign the logical port identifiers to virtual port identifiers, wherein: a sequence of virtual port identifiers is to identify a physical port path through the multiple switches from the source to the destination, a logical port identifier of the logical port identifiers is associated with one or more virtual port identifiers of the virtual port identifiers, and a virtual port identifier of the virtual port identifiers is associated with one or fewer physical links between ports of different switches.

Example 2 includes one or more examples, and includes the switch performing source routing of the packet to route the packet from a source network interface device to a destination network interface device through the multiple switches.

Example 3 includes one or more examples, wherein a mapping of logical port identifiers to physical ports or logical to virtual port identifiers is based on a translation table.

Example 4 includes one or more examples, wherein the virtual port identifier is associated with two or more physical links between ports of different switches.

Example 5 includes one or more examples, wherein the multiple switches apply a same conversion scheme to determine the assignment of the logical port identifiers to virtual port identifiers.

Example 6 includes one or more examples, wherein the topology comprises one or more of: all-to-all, HyperX, Megafly, PolarFly, SlimFly, Dragonfly, Fat-Tree, or PolarStar.

Example 7 includes one or more examples, and includes a first interface to an input port; a second interface to an output port; and switch circuitry configured to: perform source routing of a packet to route the packet from a source to a destination through multiple switches by specification of a path of logical port identifiers through the multiple switches, wherein the multiple switches are to translate the logical port identifiers into physical ports based on configurations and wherein the path of the packet through the multiple switches is based on a topology of switches.

Example 8 includes one or more examples, wherein: at least one of the multiple switches is to: access a translation table to convert a logical port identifier of the logical port identifiers to a physical port of the physical ports.

Example 9 includes one or more examples, wherein: at least one of the multiple switches is to: perform arithmetic to convert a logical port identifier of the logical port identifiers to a physical port of the physical ports.

Example 10 includes one or more examples, wherein: at least one of the multiple switches is to: convert a logical port identifier of the logical port identifiers to a virtual port identifier and convert the virtual port identifier to a physical port of the physical ports.

Example 11 includes one or more examples, wherein the virtual port identifier is associated with two or more physical links between ports of different switches.

Example 12 includes one or more examples, wherein the multiple switches are to apply a same conversion scheme to determine an assignment of the logical port identifiers to virtual port identifiers.

Example 13 includes one or more examples, wherein the topology comprises one or more of: all-to-all, HyperX, Megafly, PolarFly, SlimFly, Dragonfly, Fat-Tree, or PolarStar.

Example 14 includes one or more examples, and includes at least one non-transitory computer-readable medium comprising instructions stored thereon, that if executed by one or more circuitry of a router, cause the one or more circuitry of the router to: perform source routing of a packet to route the packet from a source to a destination through multiple routers by specification of a path of logical port identifiers through the multiple routers, wherein the multiple routers are to translate the logical port identifiers into physical ports based on configurations and wherein the path of the packet through the multiple routers is based on a topology of the multiple routers.

Example 15 includes one or more examples, wherein: at least one of the multiple routers is to: access a translation table to convert a logical port identifier of the logical port identifiers to a physical port of the physical ports.

Example 16 includes one or more examples, wherein: at least one of the multiple routers is to: perform arithmetic to convert a logical port identifier of the logical port identifiers to a physical port of the physical ports.

Example 17 includes one or more examples, wherein: at least one of the multiple routers is to: convert a logical port identifier of the logical port identifiers to a virtual port identifier and convert the virtual port identifier to a physical port of the physical ports.

Example 18 includes one or more examples, wherein: the virtual port identifier is associated with two or more physical links between ports of different routers.

Example 19 includes one or more examples, wherein: the multiple routers are to apply a same conversion scheme to determine an assignment of the logical port identifiers to virtual port identifiers.

Example 20 includes one or more examples, wherein the topology comprises one or more of: all-to-all, HyperX, Megafly, PolarFly, SlimFly, Dragonfly, Fat-Tree, or PolarStar.

1. A method comprising:
in a switch among multiple switches connected according to a topology in a network on chip (NoC):
to route a packet from a source to a destination through the multiple switches:
assign logical port identifiers to links between switches of the multiple switches; and
assign the logical port identifiers to virtual port identifiers, wherein:
a sequence of virtual port identifiers is to identify a physical port path through the multiple switches from the source to the destination,
a logical port identifier of the logical port identifiers is associated with one or more virtual port identifiers of the virtual port identifiers, and
a virtual port identifier of the virtual port identifiers is associated with one or fewer physical links between ports of different switches.

2. The method of claim 1, comprising:
the switch performing source routing of the packet to route the packet from a source network interface device to a destination network interface device through the multiple switches.

3. The method of claim 1, wherein a mapping of logical port identifiers to physical ports or logical to virtual port identifiers is based on a translation table.

4. The method of claim 1, wherein the virtual port identifier is associated with two or more physical links between ports of different switches.

5. The method of claim 1, wherein the multiple switches apply a same conversion scheme to determine the assignment of the logical port identifiers to virtual port identifiers.

6. The method of claim 1, wherein the topology comprises one or more of: all-to-all, HyperX, Megafly, PolarFly, SlimFly, Dragonfly, Fat-Tree, or PolarStar.

7. An apparatus comprising:
a first interface to an input port;
a second interface to an output port; and
switch circuitry configured to:
perform source routing of a packet to route the packet from a source to a destination through multiple switches by specification of a path of logical port identifiers through the multiple switches, wherein the multiple switches are to translate the logical port identifiers into physical ports based on configurations and wherein the path of the packet through the multiple switches is based on a topology of switches.

8. The apparatus of claim 7, wherein:
at least one of the multiple switches is to:
access a translation table to convert a logical port identifier of the logical port identifiers to a physical port of the physical ports.

9. The apparatus of claim 7, wherein:
at least one of the multiple switches is to:
perform arithmetic to convert a logical port identifier of the logical port identifiers to a physical port of the physical ports.

10. The apparatus of claim 7, wherein:
at least one of the multiple switches is to:
convert a logical port identifier of the logical port identifiers to a virtual port identifier and
convert the virtual port identifier to a physical port of the physical ports.

11. The apparatus of claim 10, wherein the virtual port identifier is associated with two or more physical links between ports of different switches.

12. The apparatus of claim 10, wherein the multiple switches are to apply a same conversion scheme to determine an assignment of the logical port identifiers to virtual port identifiers.

13. The apparatus of claim 10, wherein the topology comprises one or more of: all-to-all, HyperX, Megafly, PolarFly, SlimFly, Dragonfly, Fat-Tree, or PolarStar.

14. At least one non-transitory computer-readable medium comprising instructions stored thereon, that if executed by one or more circuitry of a router, cause the one or more circuitry of the router to:
perform source routing of a packet to route the packet from a source to a destination through multiple routers by specification of a path of logical port identifiers through the multiple routers, wherein the multiple routers are to translate the logical port identifiers into physical ports based on configurations and wherein the path of the packet through the multiple routers is based on a topology of the multiple routers.

15. The computer-readable medium of claim 14, wherein:
at least one of the multiple routers is to:
access a translation table to convert a logical port identifier of the logical port identifiers to a physical port of the physical ports.

16. The computer-readable medium of claim 14, wherein:
at least one of the multiple routers is to:
perform arithmetic to convert a logical port identifier of the logical port identifiers to a physical port of the physical ports.

17. The computer-readable medium of claim 14, wherein:
at least one of the multiple routers is to:
convert a logical port identifier of the logical port identifiers to a virtual port identifier and
convert the virtual port identifier to a physical port of the physical ports.

18. The computer-readable medium of claim 17, wherein:
the virtual port identifier is associated with two or more physical links between ports of different routers.

19. The computer-readable medium of claim 17, wherein:
the multiple routers are to apply a same conversion scheme to determine an assignment of the logical port identifiers to virtual port identifiers.

20. The computer-readable medium of claim 17, wherein the topology comprises one or more of: all-to-all, HyperX, Megafly, PolarFly, SlimFly, Dragonfly, Fat-Tree, or PolarStar.
